(19) United States
(12) Patent Application Publication
(10) Pub. No.: US 2025/0115204 A1
(43) Pub. Date: Apr. 10, 2025

(54) Debris Mover for Mounting on Highway Trucks

(71) Applicant: Betts Platinum Group, LLC, dba J-Tech, Chester Springs, PA (US)

(72) Inventors: Richard S. Johnson, Pottstown, PA (US); Collin E. Johnson, Pottstown, PA (US); Jason M. Rohrer, Elverson, PA (US)

(73) Assignee: Betts Platinum Group, PLLC, dba J-Tech, Chester Springs, PA (US)

(21) Appl. No.: 18/961,046

(22) Filed: Nov. 26, 2024

Related U.S. Application Data
(63) Continuation-in-part of application No. 17/172,888, filed on Feb. 10, 2021.
(60) Provisional application No. 62/987,552, filed on Mar. 10, 2020.

(51) Int. Cl. B60R 19/54

(52) U.S. Cl. CPC B60R 19/54; B60Y 2200/142

(57) ABSTRACT

A debris removal apparatus can be mounted on the front of a suitable vehicle for movement over the surface of the highway. The apparatus is formed with a central member and opposing wings pivotally mounted on the sides of the central member. The wings are independently pivotally movable by hydraulic cylinders forwardly and rearwardly of the central member to permit a selective placement of the debris on the shoulder of the highway. Hydraulic cylinders also control the vertical positioning of the apparatus between a lowered operative position and a raised transport position. A lightweight version of the apparatus is mountable to compact pick-up trucks and includes a plastic skin across the forward surface of the center section and the pivotally attached wings. An onboard hydraulic system powers the operation of the hydraulic cylinders. The lower edges of the central member and wings are provided with a detachable wear strip.

### CROSS-REFERENCE TO RELATED APPLICATIONS

This application is a continuation-in-part of U.S. patent application Ser. No. 17/172,888, filed on Feb. 10, 2021, which claims domestic priority on U.S. Provisional Patent Application Ser. No. 62/987,552, filed on Mar. 10, 2020, the content of which is incorporated herein by reference.

### FIELD OF THE INVENTION

This invention relates generally to an apparatus adapted to mount on the front of a truck, such as a three-quarter ton or larger pick-up truck in one version, and to mount on a light or heavy duty pick-up truck in a second, lightweight version, and, more particularly, to a debris mover that operates to remove debris from a highway to the side of the highway for the safety of the people picking up the debris.

### BACKGROUND OF THE INVENTION

Debris, such a tire treads from blown recap tires, trash, pieces falling off of automotive vehicles, etc., can accumulate on the surface of the highway and become hazards to motorists traveling on that highway. Typically, motorists report the debris on the surface of the highway and the Transportation Department of the state through which the highway runs is contacted to remove the debris from the highway. In such circumstances, a highway worker drives a highway safety truck to the location where the debris is located. This highway worker parks the vehicle on the shoulder of the roadway, then walks on the highway surface to pick-up the debris and removes it from the surface of the highway, usually placing the debris in the bed of the highway safety truck.

Such procedures for removing debris from the surface of the highway subjects the highway worker to danger from being struck by automotive vehicles traveling on the highway and trying to avoid the debris, and from being struck by the debris flying across the highway after being struck by an automotive vehicle that was not able to avoid impacting the debris while traveling on the highway. The highway worker would have a much safer work environment if the debris were positioned along the side of the highway, where the highway worker can pick-up the debris guarded by the bulk of the highway safety truck that was positioned along the side of the highway.

Accordingly, it would be desirable to provide an apparatus that would be capable of moving debris from the surface of the highway onto the side of the highway, or otherwise move the debris to a safer place for the highway worker to pick-up the debris. It would also be desirable if such an apparatus were able to be moved into multiple configurations that could perform different functions to position debris to a safer location along the side of the highway.

### SUMMARY OF THE INVENTION

It is an object of this invention to overcome the disadvantages of the prior art by providing an apparatus that will be operable when mounted on a suitable vehicle to move debris lying on the surface of the highway to the shoulder of the highway.

It is another object of this invention to provide an apparatus for moving debris from the surface of the highway onto the shoulder for a safer disposal of the debris.

It is a feature of this invention that the debris removal apparatus is formed with opposing wings that are movable relative to a fixed central member to control the placement of the debris.

It is an advantage of this invention that the opposing wings are hydraulically positionable independently of one another.

It is another feature of this invention that the opposing wings can be independently pivotally moved to positions pivoted forwardly of the central fixed portion or to positions pivoted rearwardly of the fixed central member.

It is another advantage of this invention that the positioning of both

opposing wings to a position pivoted forwardly of the fixed central member enables the debris removal apparatus to collect debris and be retained until a suitable location on the shoulder can be found for disposal of the debris.

It is still another feature of this invention that openings are formed in the debris removal apparatus to permit viewing through the apparatus.

It is still another advantage of this invention that the openings through the debris removal apparatus are covered with a mesh to keep objects from passing through the debris removal apparatus.

It is another advantage of this invention that the openings allow the passage of air through the apparatus while being moved along the highway.

It is still another object of this invention to provide the debris removal apparatus with a mounting mechanism to permit a detachable mounting of the apparatus to a suitable vehicle, such as a three-quarter ton pick-up truck.

It is yet another feature of this invention that the debris removal apparatus is pivotally connected to the mounting mechanism to enable hydraulic cylinders to move the apparatus vertically between a lowered operative position and a raised transport position.

It is yet another object of this invention that the debris removal apparatus can be used as a push bumper to move another vehicle when the apparatus is raised above the surface of the highway.

It is a further object of this invention that the debris removal apparatus is provided with a control mechanism to actuate the raising and lowering and the pivoted positioning of the opposing wings.

It is a further feature of this invention that the control mechanism limits the speed of operation of the vehicle to which the debris removal apparatus is attached while the apparatus is lowered onto the highway, but will permit the vehicle speed to be increased once the apparatus is raised to a safe level for transport.

It is yet a further feature of this invention that the debris removal apparatus is provided with a detachable wear member along a lower edge thereof to engage the surface of the highway.

It is a further advantage of this invention that the detachable wear member can be bolted onto the lower edge of the fixed central member and the opposing wings to facilitate replacement thereof.

It is still a further advantage of this invention that debris can be removed from the highway in a manner to maximize safety of individual working to remove debris from the surface of the highway.

It is another object of this invention to provide a lightweight version of the debris moving apparatus that can be mounted on a compact pick-up truck.

It is another feature of this invention that the lightweight version of the debris moving apparatus is provided with an onboard hydraulic system to power the operation of hydraulic cylinders controlling the movement of the center section and wings.

It is another advantage of this invention that the vehicle supporting the debris moving apparatus is not required to have a hydraulic system.

It is still another feature of this invention that the forward surface of the debris moving apparatus includes a plastic skin mounted to the frame of the apparatus.

It is yet a further object of this invention to provide a debris removal apparatus for displacing debris from the surface of a highway to the shoulder with an apparatus that is easy to manufacture, efficient to operate and convenient to maintain.

These and other objects, features and advantages are accomplished according to the instant invention by providing a debris removal apparatus that can be mounted on the front of a suitable vehicle for movement over the surface of the highway. The apparatus is formed with a central member and opposing wings pivotally mounted on the sides of the central member. The wings are independently pivotally movable by hydraulic cylinders forwardly and rearwardly of the central member to permit a selective placement of the debris on the shoulder of the highway. Hydraulic cylinders also control the vertical positioning of the apparatus between a lowered operative position and a raised transport position. A lightweight version of the apparatus is mountable to compact pick-up trucks and includes a plastic skin across the forward surface of the center section and the pivotally attached wings. An onboard hydraulic system powers the operation of the hydraulic cylinders. The lower edges of the central member and wings are provided with a detachable wear strip.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a rear perspective view of a debris moving apparatus incorporating the principles of the instant invention, the side wings of the apparatus being shown in a rearwardly pivoted configuration;

FIG. 2 is a front elevational view of the debris moving apparatus shown in FIG. 1;

FIG. 3 is a top plan view of the debris moving apparatus shown in FIG. 1;

FIG. 4 is an enlarged rear perspective view of the central member of the debris moving apparatus shown in FIG. 1, depicting the mounting apparatus for connecting the debris moving apparatus to a suitable vehicle for movement over the highway, such as the front platform of highway trucks equipped for mounting snow plows;

FIG. 4A is an enlarged rear perspective view of the right side wing of the debris moving apparatus shown in FIG. 1;

FIG. 5 is a front elevational view of the debris moving apparatus showing the pivoting of the side wings into a forwardly pivoted configuration relative to the central member thereof;

FIG. 6 is a right, rear perspective view of the debris moving apparatus shown in FIG. 5;

FIG. 7 is a left, rear perspective view of the debris moving apparatus shown in FIG. 5;

FIG. 8 is a schematic view of the control system for the debris moving apparatus;

FIG. 9 is a schematic front elevational view of a lightweight debris moving apparatus for mounting on compact pick-up trucks, the left wing of the apparatus having components removed to show the underlying frame structure;

FIG. 10 is a schematic top plan view of the apparatus shown in FIG. 9, the hydraulic actuators on the left side of the apparatus and all of the hydraulic hoses being removed for purposes of clarity;

FIG. 11 is schematic side elevational view of the apparatus shown in FIG. 9; and

FIG. 12 is a schematic left, front perspective view of the apparatus shown in FIG. 9.

### DETAILED DESCRIPTION OF THE PREFERRED EMBODIMENTS

Referring now to drawings, a debris moving apparatus mountable to the mount of a host highway truck to facilitate the removal of debris from the surface of the highway and incorporating the principles of the instant invention can best be seen. References to left and right, as well as front and rear can be determined from reference to the mounting mechanism of the debris moving apparatus positioned at the rear of the debris moving apparatus so that the apparatus can be mounted on the snow plow mounting device at the front of the highway truck so that the debris moving apparatus is located forwardly of the highway truck.

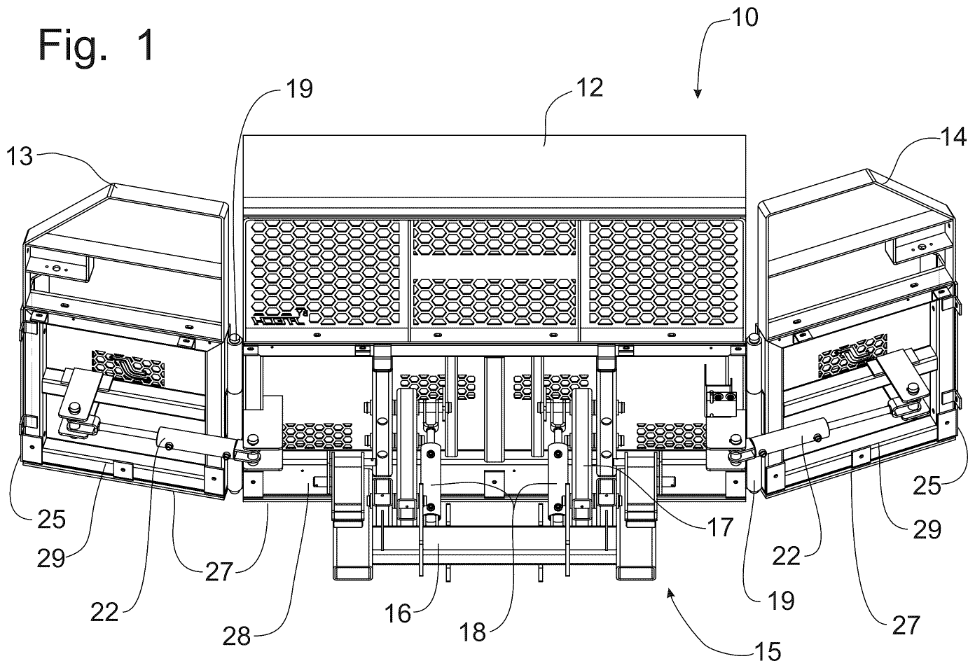

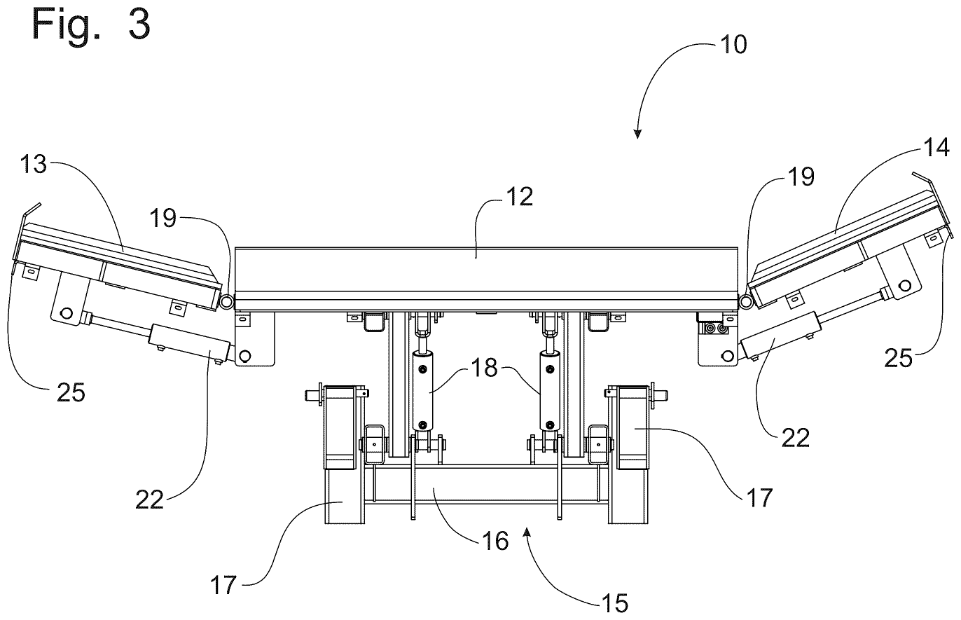

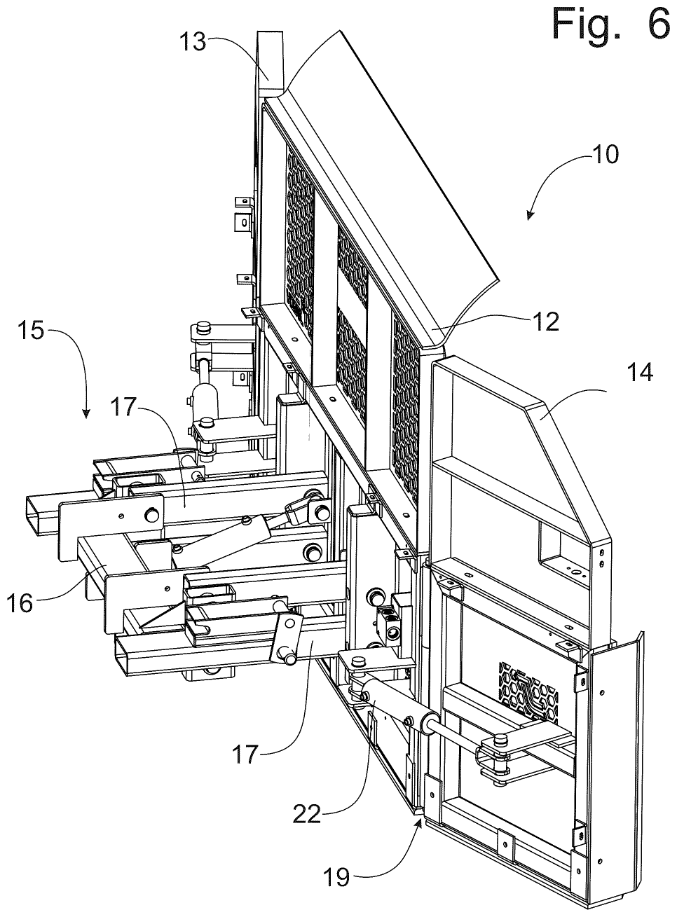

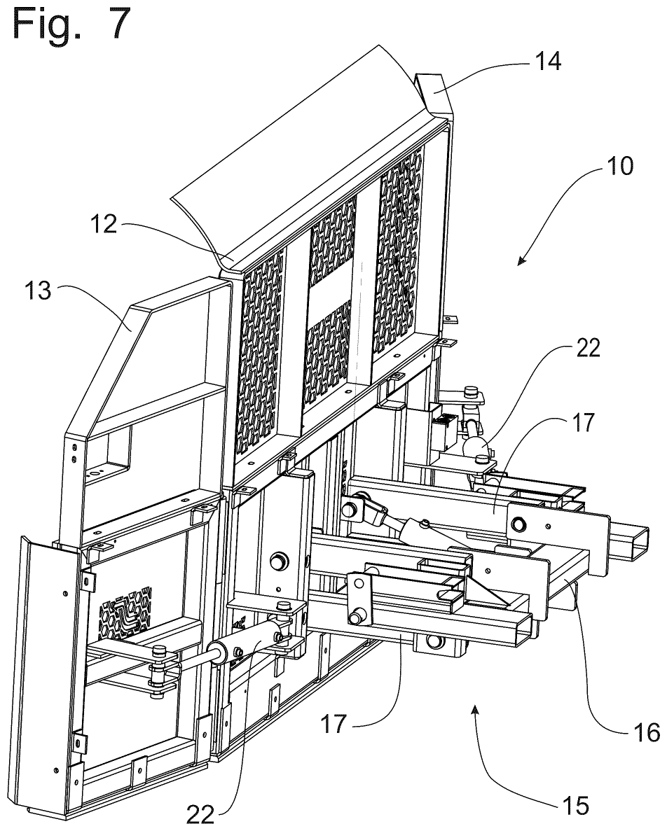

The debris moving apparatus 10 has a fixed central member 12 and a pair of opposing side wing members 13, 14 that are pivotally connected, respectively, to the left and right sides of the central member 12. The central member 12 includes a rearwardly positioned universal mounting mechanism 15, best seen in FIGS. 1 and 3, including a mounting frame 16, a pair of parallel four-bar links 17 interconnecting the mounting frame 16 and the central member 12, and a pair of lift cylinders 18, which are preferably hydraulic, but could be pneumatic cylinders as well. The provision of the four-bar links 17, best seen in FIGS. 6 and 7, enables the lift cylinders 18 to move the central member 12, along with the left and right side members 13, 14, vertically, relative to the highway truck on which the debris moving apparatus 10 is mounted, from a lowermost position adjacent the surface of the highway to a raised position spaced above the surface of the highway. Accordingly, the debris moving apparatus 10 can be positioned into the lowermost position to move debris off the surface of the highway, or into the raised position for transport and to provide a push bumper for engaging other vehicles, etc.

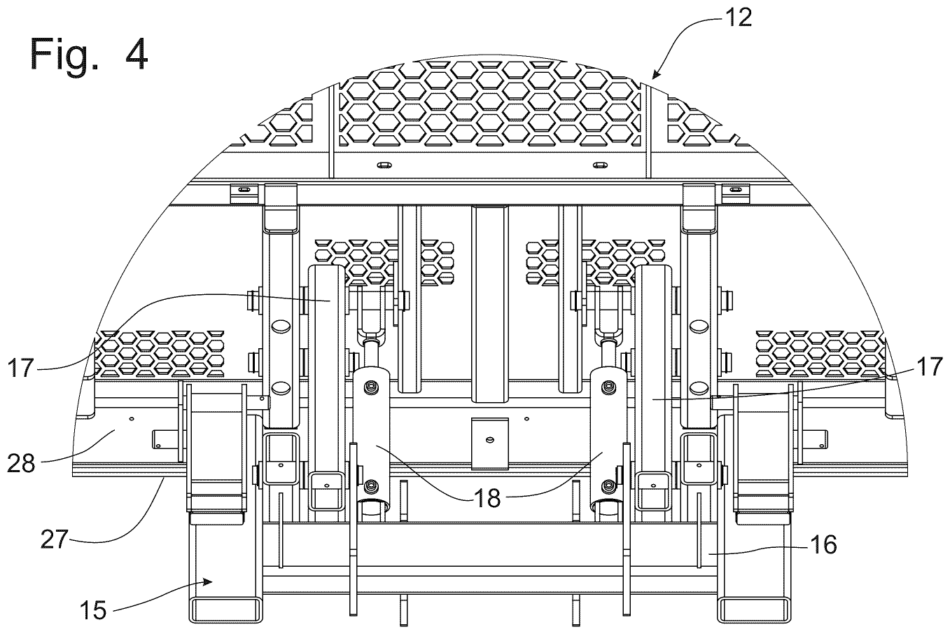

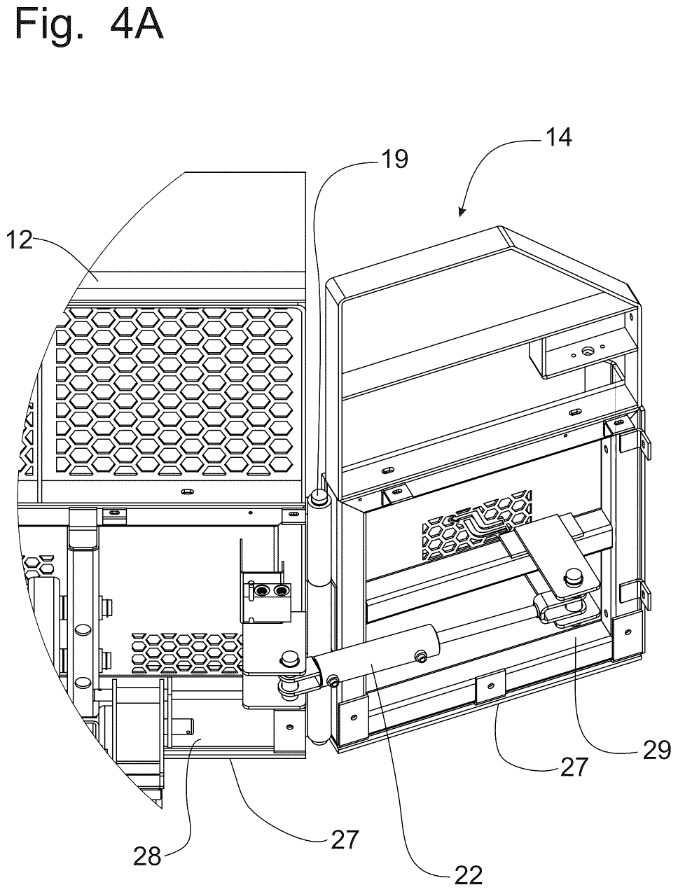

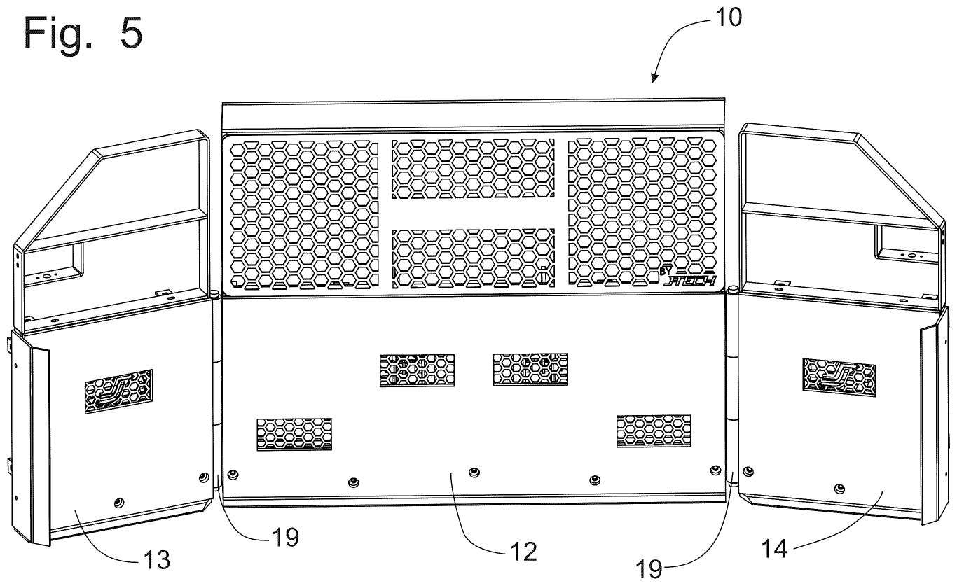

Each of the side members 13, 14 is attached to the respective end of the central member 12 by a vertically oriented pivot 19 that enables the respective side member 13, 14 to rotate about a vertical axis relative to the central member 12. Further, each respective side member 13, 14 is provided with a hydraulic swing cylinder 22 that controls the pivotal movement of the respective side member 13, 14 relative to the central member 12. As can be seen in FIGS. 1 and 4A, the side members 13, 14 can be pivoted rearwardly toward the truck on which the apparatus 10 is mounted, with elastomeric cushions 25 provided around the middle and end portions of the side members 13, 14 to prevent damage to the truck fenders. Also, as can be seen in FIGS. 5-7, the side members 13, 14 can be pivoted forwardly relative to the central member 12 into the direction of travel for operational functions as will be described in greater detail below.

Appropriately positioned openings through the structure of the debris moving apparatus 10 establishes air vents that allow for proper air flow through the apparatus 10 while mounted on a highway truck, enabling the debris moving apparatus 10 to be mounted on a highway truck year round. Referring now to FIGS. 1, 3, 4 and 4A, one skilled in the art will recognize that the central member 12 and the side members 13, 14 are constructed with a lower wear edge member 27 that is bolted onto the structural frame members 28, 29 of the central member 12 and side members 13, 14 to allow the lower wear edge members to be selectively removed from the debris moving apparatus 10 and replaced with new lower wear members 27. In addition, the side members 13, 14 are detachable from the central member 12 via disconnection of the pivots 19 to permit replacement thereof in the event one of more of these members 12-14 are damaged beyond repair.

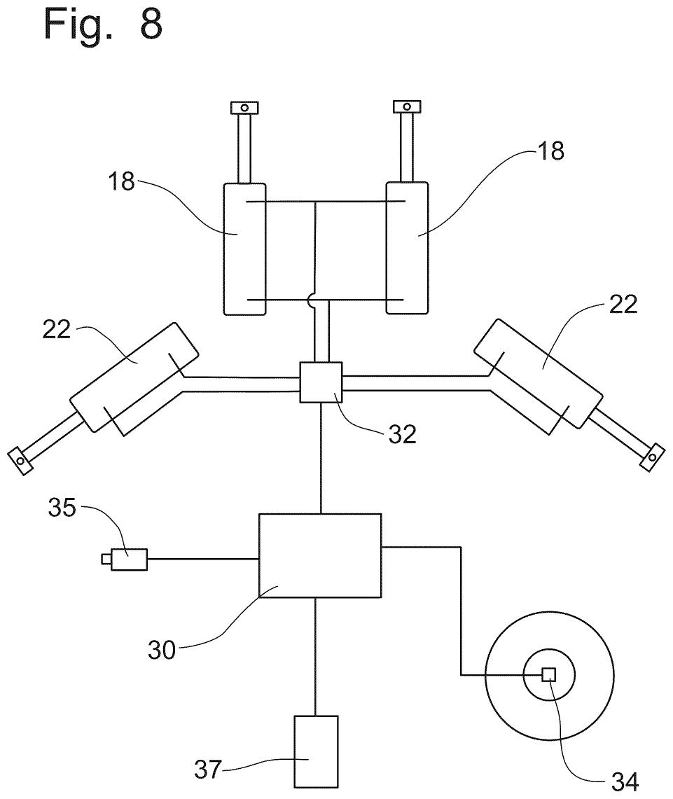

A control system 30 is provided for the debris moving apparatus 10, as is best seen in FIG. 8. The control system 30 receives signals from the truck via sensor 34 to indicate the speed at which the highway truck is traveling along the highway. The control system 30 regulates a hydraulic valve 32 distributing hydraulic fluid to the lift cylinders 18 and to the swing cylinders 22. When the highway truck is moving above a predetermined speed, the control system 30 prevents the lift cylinders 18 and the swing cylinders 22 from operating, thus maintaining the debris moving apparatus 10 in the raised transport position.

In addition, the debris moving apparatus 10 is provided with one or more cameras 35 which provide the operator of the highway truck a view, via a monitor 37, of the debris being moved by the apparatus 10 during operation of the debris moving apparatus 10 deployed in the lowermost position. The control system 30 can be operated to prevent the debris moving apparatus 10 from being raised above the lowermost position while the debris is still positioned on the highway in front of the central member 12. At a minimum, the camera 35 allows the operator to safely see the debris being removed from the surface of the highway from the cab of the highway truck.

In operation, the debris moving apparatus 10 is mounted onto the snow plow mount of standard highway trucks through attachment through the universal mounting apparatus 15. Once the hydraulic lines 39 are connected through the hydraulic valve and the hydraulic system of the highway truck, the debris moving apparatus 10 is ready for operation. The lift cylinders 18 are actuated to raise the central member 12 and the pivotally attached side members 22 to the raised transport position. Preferably, the swing cylinders 22 are also actuated to retract the side members 13, 14 rearwardly toward the highway truck to minimize the forward facing profile of the debris moving apparatus 10. The elastomeric cushions or seals 25 prevent damage to the sheet metal of the highway truck when the side members 13, 14 are fully retracted rearwardly.

The control system 30 permits the highway truck to be operated at any safe speed by the operator; however, the control system 30 also locks the hydraulic valve 32 to prevent either the lift cylinders 18 or the swing cylinders 22 to be operated when the highway truck is being operated above a predetermined highway speed. If debris has been spotted on the highway and the operator wishes to operate the debris moving apparatus 10 to remove the debris from the surface of the highway, the operator must lower the speed of operation of the highway truck below the predetermined speed before the control system 30 will allow the lowering of the debris moving apparatus 10 from the raised transport position to a lowermost operating position for engagement of the debris to be removed from the highway.

The operator can then activate the lift cylinders 18 to lower the debris moving apparatus 10 to the lowermost operative position. The control system 30 will also allow the operator to activate the swing cylinders 22 to position the side members 13, 14 into a desired configuration, pivoted relative to the central member 12. Since the swing cylinders 22 can be operated independently of one another, the operator has multiple choices of configurations to choose. Both side members 13, 14 can be moved to a position, as depicted in FIG. 1, that are both slightly rearwardly of the central member 12 to allow the debris to be moved by the apparatus 10 to either side of the highway. The camera 35 allows the operator to monitor the movement of the debris until placed off the side of the road. The operator can then park the highway truck rearwardly of the debris along the side of the highway, exit the cab of the highway truck and place the debris in the bed of the truck for removal from the shoulder of the highway.

Alternatively, the operator might select the positioning of the side members 13, 14 forwardly of the central member 12, such as the configuration shown in FIGS. 5-7, to prevent the debris from discharging from the debris moving apparatus 10, until a safe location along the side of the road can be reached, whereupon the operator can manipulate the appropriate swing cylinder 22 to pivot the selected side member 13, 14 rearwardly and allow the debris to be discharged along the side of the road for the safe engagement thereof by the operator. Such configurations are particularly useful when the debris moving apparatus is being deployed on a bridge to remove debris therefrom when the bridge does not provide an adequately large shoulder for safely allowing the operator to exit the cab of the highway truck to place the debris into the bed of the highway truck.

Once the control system 30 senses that the lift cylinders 18 and the swing cylinders 22 have been manipulated to properly position the debris moving apparatus 10 into a raised transport position, the control system 30 will allow the speed of the highway truck to be increased above the predetermined maximum safe operating speed for the deployed debris moving apparatus 10. The sensing of the proper positioning of the lift and swing cylinders 18, 22 can be established by sensors (not shown) monitoring the four-bar lift linkages 17 or the positioning of the hydraulic cylinders 18, 22 themselves, as one of ordinary skill in the art will appreciate.

Accordingly, the debris moving apparatus 10 incorporating the principles of the instant invention provides a number of features and advantages heretofore unknown in the industry. The debris moving apparatus 10 provides a safer process for highway workers to remove debris from the surface of the highway. The apparatus 10 provides a hydraulically controlled bumper that has a raised stowed, transport position that operates as a push bumper, such as is found on tow trucks, and a lowered deployed position that allows engagement with debris on the surface of the highway for safely moving the debris to the side of the highway. The universal mounting system 16 allows the apparatus 10 to be mounted onto all platforms of highway trucks that can be used to mount snow plows.

Cameras 35 can be utilized on the front of the debris moving apparatus 10 to allow the operator to safely see the debris being moved along the highway surface from the cab of the truck through monitors 37 associated with the cameras 35. The side members 13, 14 have custom fascia on the rear sides thereof to form around the sheet metal of the highway truck on which the apparatus 10 is mounted. Air vents through the debris moving apparatus 10 permit proper air flow through the apparatus 10 when placed into the raised transport position while the highway truck is operated at normal highway speeds. The bolt-on design of the lower wear members 27 on the central and side members 12-14 allows for convenient maintenance and repair of the most likely damaged component of the debris moving apparatus 10.

The control system 30 controls the operation of the debris moving apparatus 10. Sensing the operating speed of the highway truck through speed sensors 34, the control system 30 will prevent movement of the debris moving apparatus from the raised transport position to a lowered operative position when the highway truck is being operated at a speed above a predetermined speed of operation deemed to be safe for the operation of the debris moving apparatus 10. Furthermore, the control system 30 will not allow the highway truck to be operated above this predetermined safe speed of operation while the debris moving apparatus 10 is deployed into the lowermost position adjacent to the surface of the highway to engage debris thereon. Accordingly, the debris being removed from the surface of the highway stays controlled and causes minimal to no damage to the debris moving apparatus 10, thus keeping the highway truck and operator safe.

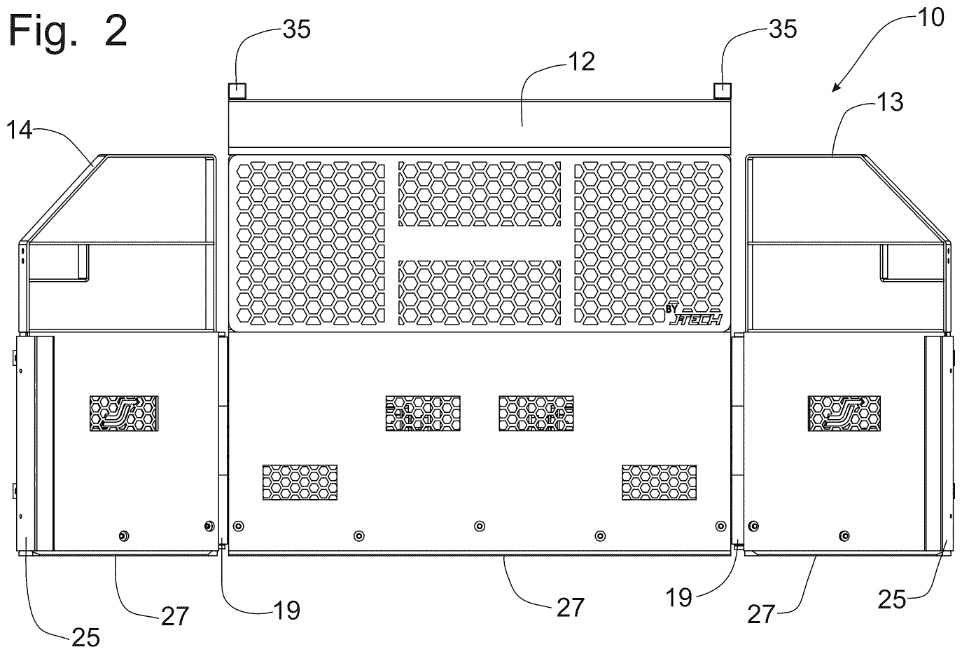

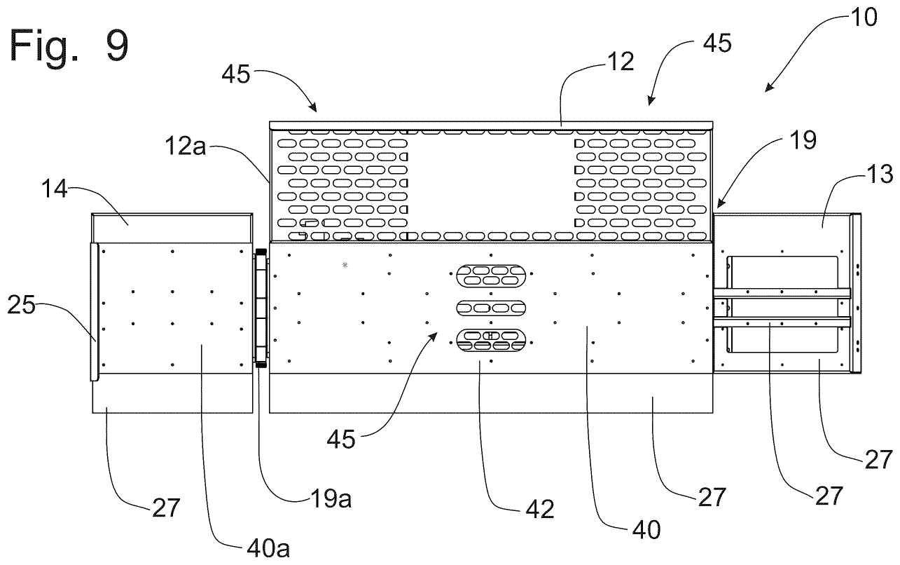

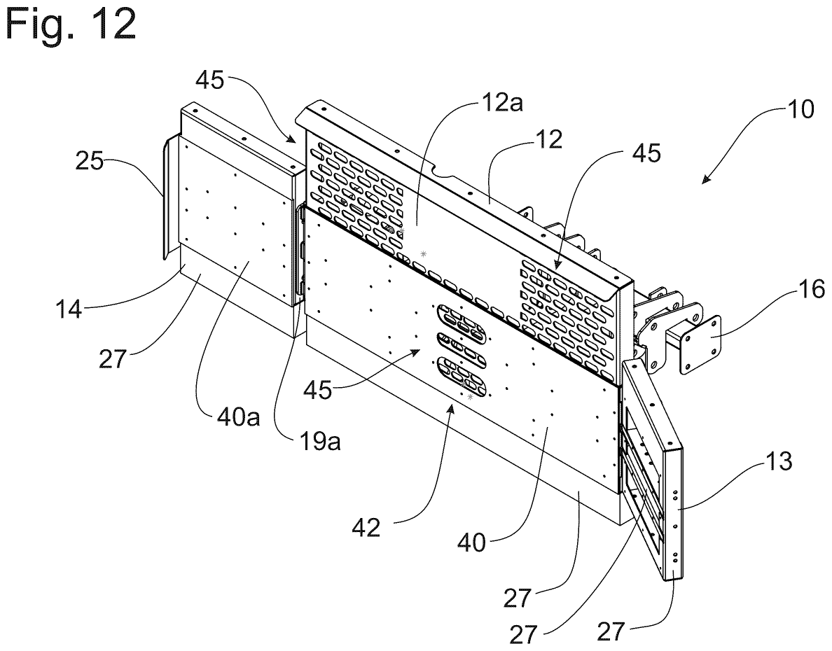

Referring now to FIGS. 9-12, a lightweight configuration of the debris moving apparatus 10 can best be seen. The lightweight configuration of the debris moving apparatus 10 is designed to be mounted on compact pick-up trucks (not shown), as opposed to the large highway trucks for which the configuration shown in FIGS. 1-8 is designed. The apparatus 10 is formed with a planar center section 12 having left and right wings 13, 14 pivotally mounted on the opposing lateral sides of the center section 12. The pivot axis 19 for the wings 13, 14 can be as described above, or because of the lighter properties of the lightweight apparatus 10, a heavy duty, vertically oriented piano hinge 19a. Irrespective of the configuration of the pivot axis 19, 19a, the wings 13, 14 are mounted for pivotal movement about the axis 19, 19a in a manner that has the distal end of the wing 13, 14 forward of the planar center section 12, or rearward thereof. Preferably, the wings 13, 14 can be pivoted approximately thirty degrees relative to the plane of the center section 12.

In FIGS. 9-12, the left wing 13 is shown with the frame 28 exposed to shown the configuration of the frame. This frame configuration 28 includes horizontal and vertical struts 29 that are used for the attachment of a plastic skin 40 to the center section 12 and wings 13, 14, as is depicted by the fasteners shown on the forward surface of the plastic skin 40. The central portion of the center section 12 is formed with a set of oval-shaped openings 42 that are vertically oriented to allow for the passage of air through the center section 12 to cool the radiator or cooler package (not shown) on the pick-up truck on which the lightweight apparatus 10 is mounted. These oval-shaped openings 42 are backed with a perforated steel panel 45 to provide stability to the plastic skin 40 around the openings 42. The wings 13, 14 and the center section 12 are constructed with a lower wear edge member 27 that is bolted onto the structural frame member 28 of the central section 12 and wings 13, 14 to allow the lower wear edge members to be selectively removed from the debris moving apparatus 10 and replaced with new lower wear members 27. As noted above, elastomeric cushions 25 are preferably used to protect the compact pick-up truck.

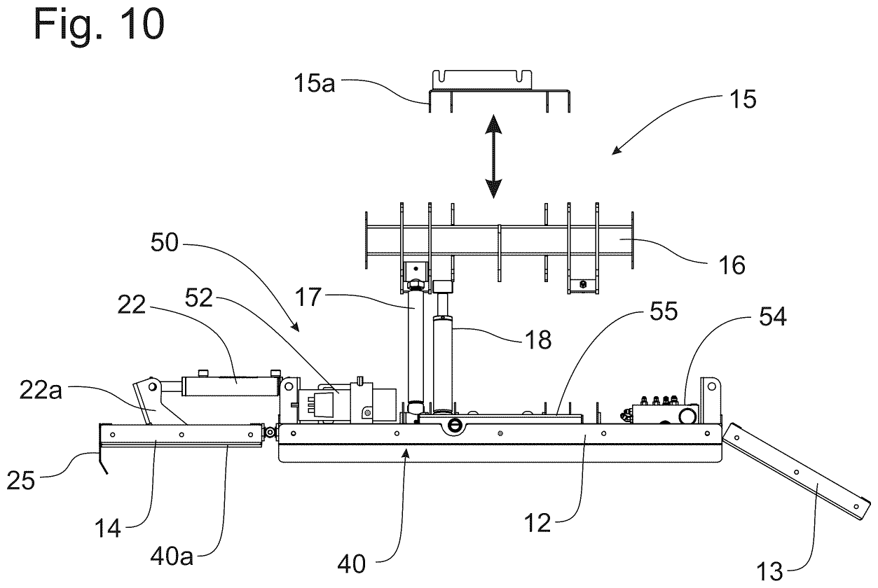

The upper portion 12a of the center section 12 is preferably formed from a perforated steel sheet 45 with a solid center portion to shield a portion of the on-board hydraulic system 50 carried by the lightweight apparatus 10 to power movement of the center portion 12 and the wings 13, 14, as will be described in greater detail below. A vehicle specific mounting bracket 15a, as depicted in FIG. 10, is mounted to the front of the compact pick-up truck (not shown). Manufacturers of compact pick-up trucks design the frame of their small pick-up truck in different configurations relative to other manufacturers and, thus the mounting bracket 15a must correspond to the frame of the pick-up truck. The lightweight apparatus 10 includes a base mounting frame 16 that has rearwardly projecting mounts that interact with each different version of the vehicle specific mounting bracket 15a.

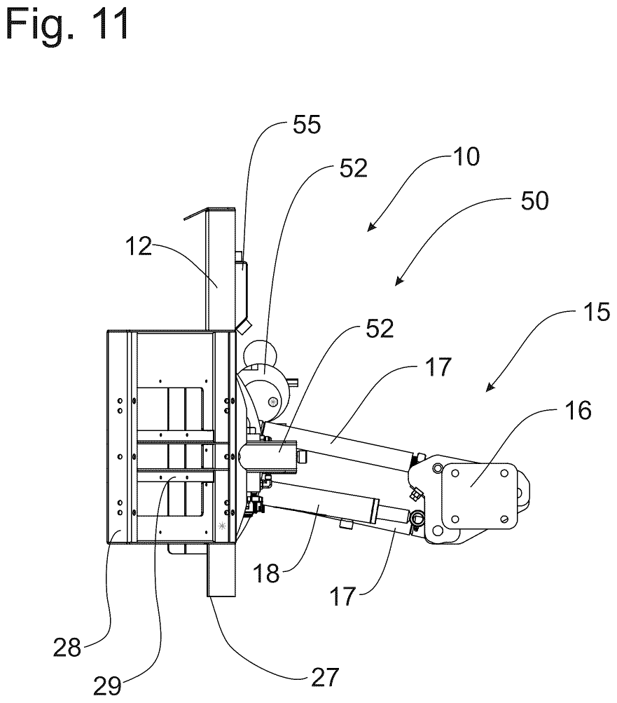

The base mounting frame 16 supports the center section 12 by a pair of upper and lower parallel links 17 and by a pair of laterally spaced hydraulic cylinders 18 (the links 17 and hydraulic cylinder 18 on the left side of the lightweight apparatus 10 being removed for purpose of clarity of the structure, but are identical to the links 17 and hydraulic cylinder 18 on the right side of the lightweight apparatus 10 as depicted in FIGS. 10 and 11). The hydraulic cylinders 18 drive the vertical movement of the center section 12 and pivotally attached wings 13, 14 between a lowered operative position adjacent the road surface and an elevated transport position. Each wing 13, 14 is powered in pivotal movement by a hydraulic cylinder 22 anchored on the adjacent lateral end of the center section 12 and attached to a mounting arm 22a connected to the frame 28 of the respective wing 13, 14. The hydraulic cylinder 22 is sized to provide the full range of desired pivotal movement of the wings 13, 14 from a position forward of the center section 12 to a position rearward of the center section 12. Preferably, the wings 13, 14 are pivoted rearwardly when in the transport position to reduce wind resistance during travel.

The lightweight apparatus 10 carries an onboard hydraulic system 50 to power the movement of the hydraulic cylinders 18, 22. The hydraulic system 50 includes a reservoir 55 protected by the solid upper, center portion of the center section superstructure 12a. A hydraulic pump 52 is mounted on the rearward surface of the center section 12 is in flow communication through hydraulic hoses (not shown) with the reservoir 55 and with a solenoid control valve 54 also mounted on the rearward surface of the center section 12. The operation of the solenoid control valve 54 is through appropriate devices mounted in the operator's cabin of the pick-up truck. Selective manipulation of the electrically powered controls in the operator's cabin directs the solenoid valve 54 to divert hydraulic fluid under pressure from the pump 52 to the respective hydraulic cylinders 18, 22, affecting vertical movement of the center section 12 or the pivotal movement of the wings 13, 14.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A debris moving apparatus for removing debris from a highway surface to a position along the side of the highway, comprising:
a central member supporting a mounting mechanism for connection thereof to a highway truck, said central member including a lift cylinder interconnecting with the mounting mechanism to enable vertical movement of the central member relative to said mounting mechanism between a raised transport position and a lowered operating position;
a pair of opposing side members pivotally connected to laterally opposing ends of said central member, each said side member including a swing cylinder interconnecting the corresponding said side member and said central member to affect pivotal movement of said side members, wherein said central member and said side members are formed with openings therein spaced at a distance from said laterally opposing ends of said central member and said side members, respectively, such that said openings are arranged through the central member and said side members at points internal of corresponding outer edges to form air vents allowing the flow of air through said central and side members while being transported in said raised transport position; and
a control system operatively connected to said lift and swing cylinders to prevent movement of said central and side members when said debris moving apparatus is being transported at a speed greater than a predetermined speed of movement.

2. The debris moving apparatus of claim 1 wherein said swing cylinders are operable to move the respective said side members between positions pivoted rearwardly of said central member and positions pivoted forwardly of said central member.

3. The debris moving apparatus of claim 1 wherein each of said side members and said central member includes a detachable wear member connected thereto along a lowermost edge of said side and central members.

4. The debris moving apparatus of claim 3 wherein said wear members are bolted onto a frame member corresponding to each of the respective said members and said central member.

5. The debris moving apparatus of claim 1 wherein at least one of said central member and said side members has mounted thereon a camera operatively connected to a monitor to provide an operator of said debris moving apparatus a view of debris being engaged thereby forwardly of said at least one of said central member and said side members and at an elevated position thereon when said debris moving apparatus is moved into said lowered operative position.

6. The debris moving apparatus of claim 1 wherein said control system prevents forward movement of said central member above said predetermined speed of movement when moved to said lower operative position.

7. The debris moving apparatus of claim 1 wherein said side members are independently movable through operation of the corresponding said swing cylinder.

8. The debris moving apparatus of claim 1 wherein said mounting mechanism further includes a four-bar linkage interconnecting said mounting mechanism and said central member so that said central member will remain in a vertical orientation during movement between said raised transport position and said lowered operative position.

9. An apparatus for displacing debris on a highway surface onto a shoulder of the highway, comprising:
a vertically oriented central member having a mounting mechanism attached on a rearward surface thereof to affect mounting of said central member onto a suitable vehicle;
hydraulic lift cylinders interconnecting said mounting mechanism and said central member to affect vertical movement of said central member between a lowered operative position and a raised transport position;
first and second wing members pivotally connected to opposing sides of said central member;
a swing cylinder interconnecting each of said wing members and said central member to affect pivotal movement of said first and second wing members relative to said central member, each said swing cylinder being operative independently of the opposing said swing member to permit selective orientation of said wing members to control placement of the highway debris, each of said first and second wing members being independently selectively movable to positions forwardly and rearwardly of said central member; and
openings formed in said central member and said wing members spaced at a distance from said opposing ends of said central member and said side members, respectively, such that said openings are arranged through the central member and said side members at points internal of corresponding outer edges to form air vents for the passage of air through the apparatus when said central member is placed into said raised transport position.

10. The apparatus of claim 9 wherein a portion of said openings is covered with a rigid mesh to prevent debris from passing through said openings.

11. The apparatus of claim 10 further comprising:
a control mechanism operatively connected to said lift cylinders and said swing cylinders to limit the speed of movement of said suitable vehicle below a predetermined speed of movement when said central member is placed into the lowered operative position.

12. The apparatus of claim 11 wherein said control mechanism prevents the operation of said lift cylinders and said swing cylinders when said central member is raised vertically above said lowered operative position and when said suitable vehicle is being operated at a speed of movement greater than said predetermined speed of movement.

13. The apparatus of claim 9 wherein each of said side members and said central member includes a detachable wear member connected thereto by bolts along a lowermost edge of said side and central members to a frame member thereof.

14. A debris moving apparatus for removing debris from a highway surface to a position along the side of the highway, comprising:
a central member supporting a mounting mechanism for connection thereof to a truck, said central member including a pair of hydraulic lift cylinders interconnecting with the mounting mechanism to enable vertical movement of the central member relative to said mounting mechanism between a raised transport position and a lowered operating position;
a pair of opposing wing members pivotally connected to respective laterally opposing ends of said central member, each said wing member including a hydraulic swing cylinder interconnecting the corresponding said side member and said central member to affect pivotal movement of said side members relative to said central member;
each of said wing members and said central member having a frame covered on forward surfaces thereof by a plastic skin attached to the respective said frames; and
an onboard hydraulic system operatively connected to said lift and swing cylinders to power operation thereof, said onboard hydraulic system including a reservoir, a pump and a solenoid valve through which hydraulic fluid under pressure can be directed selectively to said lift and swing hydraulic cylinders.

15. The apparatus of claim 14 wherein said central member is formed with a superstructure having left and right sections formed as mesh from perforated panels and a solid center section, said reservoir being located behind said center section.

16. The apparatus of claim 15 wherein said pump and solenoid valve are mounted on a rearward side of the frame of said central member.

17. The apparatus of claim 14 wherein said plastic skin is formed with openings arranged through the central member internally of corresponding outer edges of said central member.

18. The apparatus of claim 17 wherein said openings are oval-shaped and reinforced by mesh supported on the frame of said central member.
